(19) United States
(12) Patent Application Publication
(10) Pub. No.: US 2014/0172353 A1
(43) Pub. Date: Jun. 19, 2014

(54) Method and Apparatus for Estimating Position of a Ferromagnetic Object

(71) Applicant: U.S. Army Research Laboratory ATTN: RDRL-LOC-I, (US)

(72) Inventor: Alan S. Edelstein, Alexandria, VA (US)

(73) Assignee: U.S. Army Research Laboratory ATTN: RDRL-LOC-I, Adelphi, MD (US)

(21) Appl. No.: 13/717,736

(22) Filed: Dec. 18, 2012

(51) Int. Cl. G01V 3/08

(52) U.S. Cl. CPC G01V 3/081
USPC 702/150

(57) ABSTRACT

A method and apparatus for detecting a magnetic object comprising detecting change in a total magnetic field of an area along a first path and a second path of a magnetic sensor, fitting data points of the detected change from the first path and the second path to a curve by varying a first plurality of variables and a second plurality of variables until a best fit is achieved, calculating a first circle based on the first plurality of variables and a second circle based on the second plurality of variables and determining a position of the magnetic object at the intersection of the first and second circle.

### GOVERNMENT INTEREST

Governmental interest—The invention described herein may be manufactured, used and licensed by or for the U.S. Government.

### FIELD OF INVENTION

Embodiments of the present invention generally relate to ferromagnetic object detection and, more particularly, to a method and apparatus for estimating the position of a ferromagnetic object.

### BACKGROUND OF THE INVENTION

Gradiometers and vector magnetometer sensors are generally used to detect ferromagnetic objects (sources) in an area by measuring total magnetic field at the sensor position. A gradiometer measures the gradient of, for example, the magnetic field in its range. However, since the Earth's magnetic field is significantly larger than that of a ferromagnetic object, relative motion between the object and a sensor is required in order to detect the object. Generally, a gradiometer consists of two sensors that are connected such that the output is the difference in magnetic flux at two points in space. The sensors can either be vector sensors that measure the magnetic field in a particular direction or total field magnetic sensors. If vector sensors are used both sensors must measure the magnetic field in the same direction. Gradiometers often configure the sensors such that they are above one another, or adjacent to each other and are separated by a particular distance x. Measurements from the two sensors are measured simultaneously to cancel background noise in the magnetic field. However, signals from the gradiometer decrease rapidly, by a factor of x/r⁴ as the gradiometer moves away from the magnetic source, where x is the sensor separation distance and r is the distance between the gradiometer and a magnetic source. Thus, finding the magnetic source becomes difficult when using a dual sensor gradiometer. However, in a single sensor detector, the signal decreases by a factor of 1/r³, which is significantly better than x/r⁴ factor that applies in the case of the gradiometer having two sensors.

Vector magnetometers can be used to measure both the magnitude and direction of the total magnetic field. To measure the total field one can three orthogonal sensors for measuring the magnetic field in three dimensions. Vector magnetometers, however, are very sensitive to rotational vibrations and often are moved past a source or ferromagnetic object before the magnetometer senses the position of the object. Vector magnetometers also are subject to temperature drift and dimensional instability of the ferrate cores, and thus are unreliable in determining the position of a ferromagnetic object.

Therefore, there is a need in the art for a method and apparatus for estimating the position of a ferromagnetic object having an improved signal response and accuracy.

### BRIEF SUMMARY OF THE INVENTION

Embodiments of the present invention relate to a method for detecting a magnetic object comprising detecting change in a total magnetic field of an area along a first path and a second path of a magnetic sensor, fitting data points of the detected change from the first path and the second path to a curve by varying a first plurality of variables and a second plurality of variables until a best fit is achieved, calculating a first circle based on the first plurality of variables and a second circle based on the second plurality of variables and determining a position of the magnetic object at the intersection of the first and second circle.

Another embodiment of the present invention is directed to a method for detecting a magnetic object comprising detecting change in a total magnetic field of an area along one or more paths of a magnetic sensor, fitting data points of the detected change from the one or more paths to a curve by varying a plurality of variables until a best fit is achieved for the one or more paths, calculating one or more circles based on the plurality of variables; and determining a position of the magnetic object on the one or more circles.

Another embodiment of the present invention is directed to an apparatus for detecting a magnetic object comprising a single sensor for detecting change in a total magnetic field of an area along a first path and a second path of a magnetic sensor and a data processing module for fitting data points of the detected change from the first path and the second path to a curve by varying a first plurality of variables and a second plurality of variables until a best fit is achieved, calculating a first circle based on the first plurality of variables and a second circle based on the second plurality of variables, and determining a position of the magnetic object at the intersection of the first and second circle.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration depicting a detector for detecting a ferromagnetic object in accordance with exemplary embodiments of the present invention;

FIG. 3 is a flow diagram of a method for detecting a ferromagnetic object in accordance with exemplary embodiments of the present invention;

FIG. 2 is an illustration of a detector following two separate paths to locate a ferromagnetic object in accordance with exemplary embodiments of the present invention; and

FIG. 4 is an illustration of a detector showing the estimation of a path of closest approach to a ferromagnetic target object in accordance with exemplary embodiments of the present invention.

### DETAILED DESCRIPTION OF THE INVENTION

Embodiments of the present invention comprise a method and apparatus for detecting a ferromagnetic object in an area using a magnetic sensor, and in some embodiments, only a single sensor forms the magnetic sensor. The sensor detects a total magnetic field of an area, and, if a ferromagnetic object exists in the area, the total magnetic field will be altered as an operator of the sensor moves along a path towards the ferromagnetic object. The sensor takes multiple magnetic field measurements at different times as it moves along the path, which measurements are used to establish that a ferromagnetic object is some unknown distance away. The magnetic field measurements are plotted and fit to a predetermined curve. The curve has several parameters which are modified until a best fit of the data is established with the curve. The parameters determines an estimate of the magnetic moment of the ferromagnetic object, as well as the radius of a circle, on a plane perpendicular to the direction of the sensor's path, upon which the ferromagnetic object lies. The sensor is then moved along a different path to establish a second circle in a similar manner, upon which the ferromagnetic object lies. One of the intersections of these two circles is an accurate approximation of the position of the ferromagnetic object. In other embodiments, if the ferromagnetic object does not lie in the plane in which the sensor is moving in, three paths must be taken by the sensor, thereby resulting in three computed circles. The intersection point of these three circles signifies the location of the ferromagnetic object.

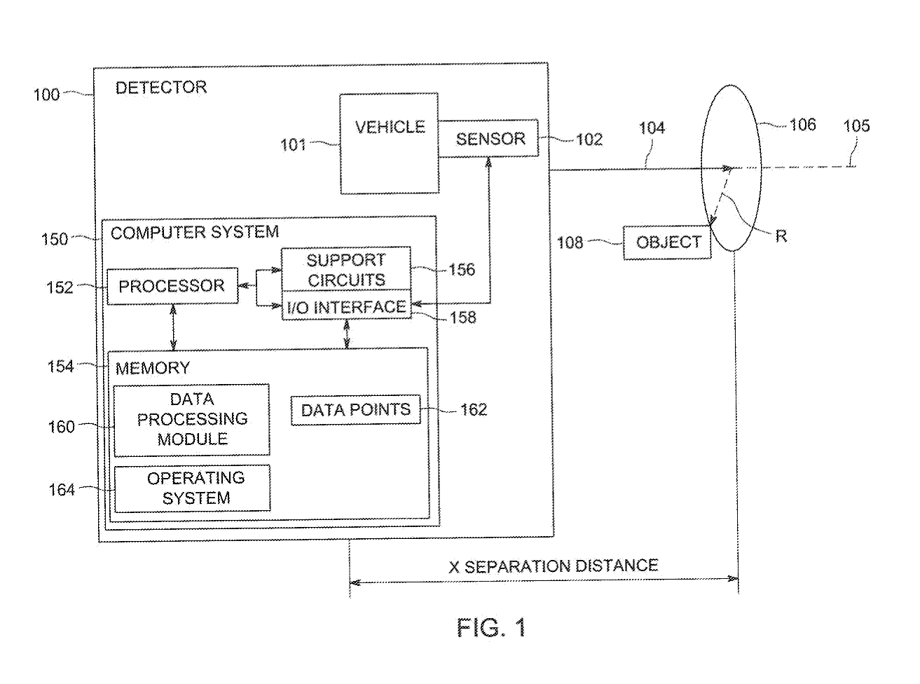

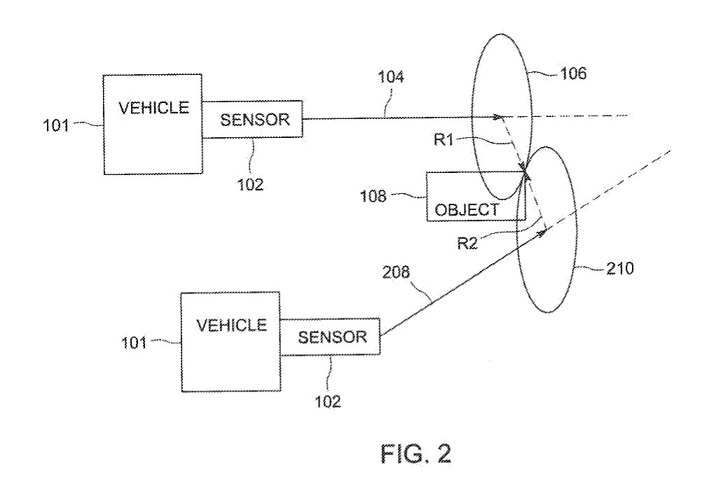

FIG. 1 is an illustration depicting a detector 100 detecting a ferromagnetic object in accordance with exemplary embodiments of the present invention. The detector 100 comprises a sensor 102 affixed to a vehicle 101. The sensor 102 is also coupled to a computer system 150.

The sensor 102 is, according to some embodiments, a magnetic sensor that measures total magnetic field. The sensor 102 is, according to an embodiment, affixed to a vehicle 101. An optically pumped magnetometer is an example of a total field sensor that may be used in according to one embodiment. Another example of a sensor system that can determine the total field is the combination of three vector magnetometers with their sense directions perpendicular to one another. In other embodiments, the sensor 102 can be affixed to any object such as a drill, an unmanned vehicle, or the like. According to this embodiment, the vehicle 101 moves in a straight line, according to a path 104 towards an object 108. The object 108 is generally an object that is a source of magnetic field, such as a ferromagnetic object.

According to an exemplary embodiment of the present invention, the detector 100 travels on a predetermined path 104 in a particular direction in a testing area by way of the vehicle 101. During the travel time, the object 108 and the detector 100 have a separation distance that can be described by the variable “x”. However, it is important to note that this is not a shortest line distance to the object 108, but represents the distance to the center of a circle 106 upon which the object 108 is predicted to lie. The circle 106 lies in a plane perpendicular to the path 104 of the detector 100.

The direction of the detector 100 along path 104 is assigned as the “x” axis 105, if the testing area is taken as a two dimensional grid, viewed either from a top view or a side view. As the vehicle 101 travels the path 104, the sensor 102 takes measurements of the magnetic field B. The magnetic field measurements B are recorded along with the corresponding current “x” value of the detector 100 at a plurality of points along the x-axis 105. The magnetic field measurements B and their corresponding x distances are paired and stored in memory 154 as sets of data points 162. Each pair of the data points 162 represent a correspondence between the magnetic field B at a particular position x along path 104.

The sensor 102 is coupled to the computer system 150 in accordance with embodiments of the present invention. The computer system 150 includes a processor 152, a memory 154 and various support circuits 156. The processor 152 may include one or more microprocessors known in the art, and/or dedicated function processors such as field programmable gate arrays programmed to perform dedicated processing functions. The support circuits 156 for the processor 152 include microcontrollers, application specific integrated circuits (ASIC), cache, power supplies, clock circuits, data registers, input/output (I/O) interface 158, and the like. The I/O interface 158 may be directly coupled to the memory 154 or coupled through the supporting circuits 156. The I/O interface 158 may also be configured for communication with input devices and/or output devices, such as, network devices, various storage devices, mouse, keyboard, displays, sensors and the like. According to one embodiment, the I/O interfaces 158 are coupled to the sensor 102.

The memory 154 stores non-transient processor-executable instructions and/or data that may be executed by and/or used by the processor 152. These processor-executable instructions may comprise firmware, software, and the like, or some combination thereof. Modules having processor-executable instructions that are stored in the memory 504 comprise the data processing module 160. As noted above memory 154 also stores the set of data points 162 from the sensor 102.

The computer 150 may be programmed with one or more operating systems (generally referred to as operating system (OS) 164), that may include OS/2, Java Virtual Machine, Linux, Solaris, Unix, HPUX, AIX, Windows, Windows95, Windows98, Windows NT, and Windows 2000, Windows ME. Windows XP, Windows Server, among other known platforms. At least a portion of the operating system 164 may be disposed in the memory 154. In an exemplary embodiment, the memory 154 may include one or more of the following: random access memory, read only memory, magneto-resistive read/write memory, optical read/write memory, cache memory, magnetic read/write memory, and the like, as well as signal-bearing media, not including non-transitory signals such as carrier waves and the like.

Generally, it can be assumed that the sensor 102 is in the far field region where the magnetic field of the object 108 is that of a dipole. The magnetic field of a dipole is given by:

$$B = \frac{\sqrt{{3}^{{( {m}_{x} x + {m}_{y} y + {m}_{z} z )}^{2} /} ( {x}^{2} + {y}^{2} + {z}^{2} ) + ( {m}_{x}^{2} + {m}_{y}^{2} + {m}_{z}^{2} )}}{{( {x}^{2} + {y}^{2} + {z}^{2} )}^{3 / 2}}$$

Once the path 104 has been travelled by the detector 100 and an predetermined number of data points 162 have been recorded as a an appropriate sample size, the data points 162 are passed to the data processing module 160.

The data processing module 160 determines a circle 106 on which the abject 108 lays at a radius R from the path 104 of the sensor 102. According to this embodiment, an x-axis is established in an observed area, that can be represented by a horizontal or vertical line, e.g., x-axis 105 in FIG. 1. The measurements from the sensor 102 measure the total field B as a function of the position along the x-axis 105. The origin of the x-axis is arbitrarily selected and according to one embodiment, the origin is at the left most position in the observed area

The data processing module 160 uses the following approximate formula:

$$B = \frac{m 1}{{[ {( x - m 2 )}^{2} + m {3}^{2} ]}^{n}}$$

to represent a curve, and then fits the set of data points 162 to the curve. The parameters m1, m2 and m3 represent, correspondingly, the magnitude of the magnetic moment of object 108, the position of the object 108 and the radius R of the circle 106. According to some embodiments, n should be equal to 3/2. The value “x” is the position of the detector 100 on the x axis 105. The parameters m1, m2 and m3 are varied to produce a best fit of the data points to the curve represented by eq. 1. When the best fit is produced, the value of m3 is taken as the radius R of circle 106, m2 is the position of the plane, and the ferromagnetic moment of the object is proportional to m1. However, the object 108 may lie on any portion of the circle R, thus a more precise location is sought.

FIG. 2 illustrates a detector following two separate paths to locate a ferromagnetic object in accordance with exemplary embodiments of the present invention. The reference numbers used in FIG. 2 that are similar to the reference numbers used in FIG. 1 refer to the same elements. A second path 208 is shown which is traveled by the detector 100, where magnetic field measurements are taken as a function of the position of the detector 100 along path 208. The magnetic field measurements B captured by the sensor 102, along with the x-axis positional data, are recorded as data points 162 in memory 154 in a manner similar to that described above for the first path 104. The data processing module 160 then does a second best fit to establish a second radius R2 of a second circle 210 upon which the ferromagnetic object is predicted to lie. It is predicted that the approximate position of the object 108 lies at one of the intersection points of the first circle 106 and second circle 210.

Thus, the path 104 is the initial path of the detector 100 that gives a first circle 106 with a radius R. However, a second path is also required to be travelled to identify where the object 108 lies on the circle 106.

According to even further embodiments, more than one sensor is used then the sensors can be moved on multiple paths at the same time and the data processing module 160 predicts the position of the ferromagnetic object 108 more quickly.

In other embodiments the above described ferromagnetic detector can be used to find the position of sources of alternating current (AC) fields, in which case the fitting function is generalized to:

$$B = \frac{m 1}{{[ {( x - m 2 )}^{2} + m {3}^{2} ]}^{n}}$$

where n is determined in the near field region. In the AC case, fall off with distance may be different than n=3/2.

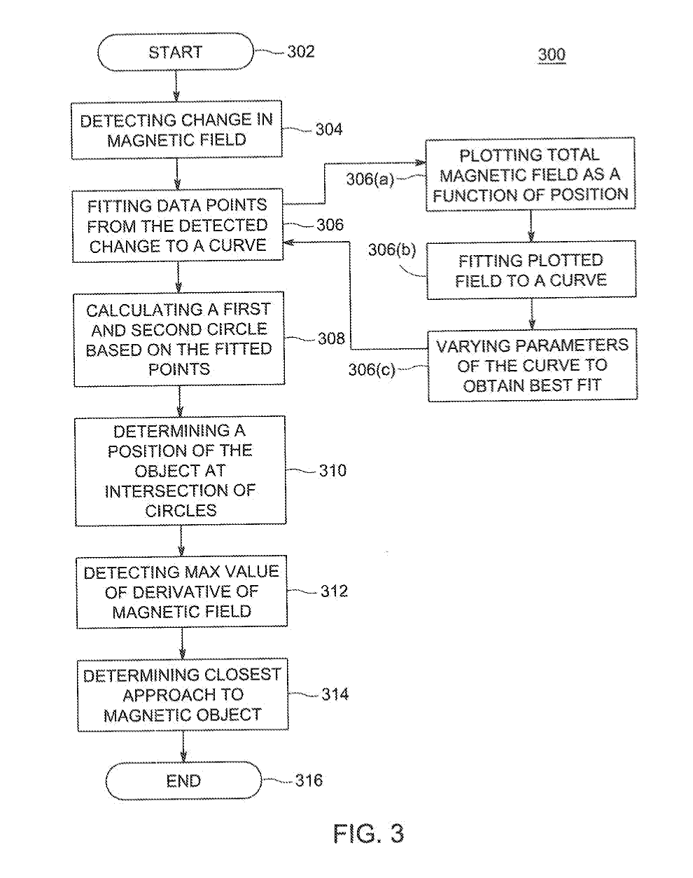

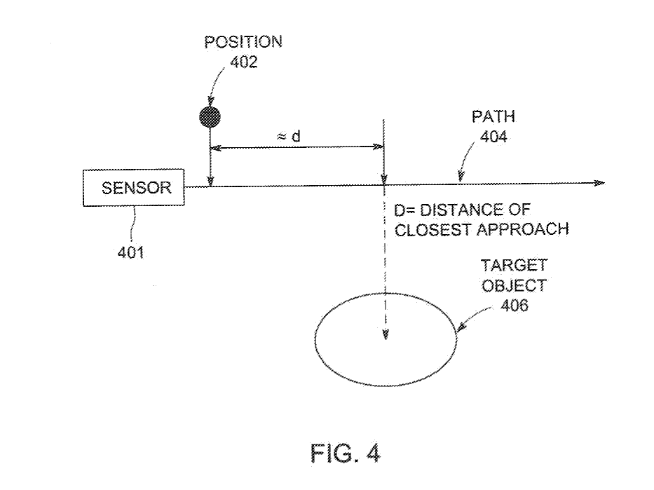

FIG. 3 is a flow diagram of a method 300 for detecting a magnetic object in accordance with exemplary embodiments of the present invention. The method 300 is an exemplary implementation of the data processing module 160 from FIG. 1 as executed by the processor 152. The method 300 will be described with reference to FIGS. 2 and 4. The method begins at step 302 and proceeds to step 304.

At step 304, the sensor 102 detects change in a total magnetic field of an area along a first path and a second path of the sensor. Initially, the sensor 102 traverses the area according to a first path 104, taking measurements as the distance changes between the sensor 102 and the object 108. Subsequently, the sensor 102 traverses the area according to a second path 208.

At step 306, the measurements taken on each path are considered as data points and are fitted to a curve. According to an exemplary embodiment, the curve is represented by the equation:

$$B = \frac{m 1}{{[ {( x - m 2 )}^{2} + m {3}^{2} ]}^{n}} \qquad ( eq . 1 )$$

with n usually equal to 3/2. Equation 1 represents the magnetic field at a particular distance “x” away from the ferromagnetic object 108. The parameters m1, m2 and m3 represent a number that is proportional to the magnitude of the magnetic moment, the position of the object on the x-axis (as defined by the area) and the radius of the circle, respectively. The proportionality constant depends on the sensitivity of the sensor.

The method 300 proceeds to sub-step 306(a), where the data processing module 160 plots the total magnetic field measurements of the sensor 102 as a function of position along an established x-axis. At sub-step 306(b), the plotted points are fit to the curve described by equation 1 above. At step 306(c), parameters of the curve are varied to obtain the best fit of the plotted points to the curve.

The method 300 then proceeds to step 308. At step 308, the data processing module 160 calculates the first circle 106 and the second circle 210 based on the fitted data points. The radius R1 of the first circle 106 is the distance from the path 104 of the sensor 102 to the magnetic object 108. The magnetic object 108 lies on the first circle 106 at radius R1 from the path 104, where R1 corresponds to m3 in equation 1. The radius R2 of the second circle 210 is the distance from the path 208. The radius R2 forms the second circle 210 upon which the object 108 also lies.

At step 310 the position of the object 108 is determined as the intersection point of the first circle 106 and the second circle 210. In some instances, the first circle 106 and second circle 210 intersect at two points. In those instances, both points are treated as potential positions of the ferromagnetic object 108. This occurs when the object is not in the plane formed by the two paths 104 and 208.

Referring briefly to FIG. 4, a sensor 401 is shown which travels on a path 404, and upon such travel, measures a fluctuating magnetic field B. It is noted that the derivative of the magnetic field B ((dB/dx)/B) approaches a maximum value according to a plot of the measured magnetic field B as a function of x.

According, referring again to FIG. 3, In certain embodiments of the present invention, the method 300 then proceeds to step 312, where a maximum value of the derivative of the magnetic field with respect to the x position ((dB/dx)/B) is observed.

At step 314, the method 300 determines that the position 402 representing distance “d” is approximately equal to the distance “D” shown in FIG. 4, which is the path of closest approach to the ferromagnetic target object 406 from the path 404 allowing for navigation or avoidance of the target object 406. The method then proceeds to step 316, where the method ends.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

Various elements, devices, modules and circuits are described above in associated with their respective functions. These elements, devices, modules and circuits are considered means for performing their respective functions as described herein. While the foregoing is directed to embodiments of the present invention, other and further embodiments of the invention may be devised without departing from the basic scope thereof, and the scope thereof is determined by the claims that follow.

1. A method for detecting a magnetic object comprising:
detecting change in a total magnetic field of an area along a first path and a second path of a magnetic sensor;
fitting data points of the detected change from the first path and the second path to a curve by varying a first plurality of variables and a second plurality of variables until a best fit is achieved;
calculating a first circle based on the first plurality of variables and a second circle based on the second plurality of variables; and
determining a position of the magnetic object at the intersection of the first and second circle.

2. The method of claim 1 wherein fitting data points further comprises:
plotting the total magnetic field as a function of a position of the magnetic object on an x-axis;
fitting the plotted field to the curve represented by the equation:
$$B = \frac{m 1}{{[ {( x - m 2 )}^{2} + m {3}^{2} ]}^{n}} ;$$
and
varying parameters m1, m2 and m3 to obtain the best fit of the plotted field to the curve, where the parameters m1, m2 and m3 represent a number proportional to the magnitude of the magnetic moment, a position of the object on the x-axis and a radius of the circle, respectively.

3. The method of claim 2 where n=3/2.

4. The method of claim 1 further comprising:
detecting a maximum value of the derivative of the detected magnetic field; and
determining a distance of closest approach to the magnetic object at the position where the maximum is detected.

5. The method of claim 1 wherein the magnetic object is one of a mine, an improvised explosive device, a buried object, and a generator.

6. The method of claim 1 further comprising positioning the sensor on one of a vehicle or a mobile drill.

7. The method of claim 1 wherein the first circle lines on a plane that is perpendicular to the first path and the second circle lies on a plane that is perpendicular to the second path.

8. The method of claim 1 comprising the object travelling on a first and second path in place of the sensor.

9. The method of claim 1 wherein the magnetic sensor is an optically pumped magnetometer.

10. A method for detecting a magnetic object comprising:
detecting change in a total magnetic field of an area along one or more paths of a magnetic sensor;
fitting data points of the detected change from the one or more paths to a curve by varying a plurality of variables until a best fit is achieved for the one or more paths;
calculating one or more circles based on the plurality of variables; and
determining a position of the magnetic object on the one or more circles.

11. An apparatus for detecting a magnetic object comprising:
a sensor for detecting change in a total magnetic field of an area along a first path and a second path of a magnetic sensor; and
a data processing module for;
fitting data points of the detected change from the first path and the second path to a curve by varying a first plurality of variables and a second plurality of variables until a best fit is achieved;
calculating a first circle based on the first plurality of variables and a second circle based on the second plurality of variables; and
determining a position of the magnetic object at the intersection of the first and second circle.

12. The apparatus of claim 11 wherein data processing module further:
plots the total magnetic field as a function of a position of the magnetic object on an x axis;
fits the plotted field to the curve represented by the equation:
$$B = \frac{m 1}{{[ {( x - m 2 )}^{2} + m {3}^{2} ]}^{n}} ;$$
and
varies parameters m1, m2 and m3 to obtain the best fit of the plotted field to the curve.

13. The apparatus of claim 12 where the data processing module sets n as “3/2”.

14. The apparatus of claim 11, wherein the data processing module further:
detects a maximum value of the derivative of magnetic field over the change in distance to the magnetic object divided by the magnetic field; and
determines a distance of closest approach to the magnetic object at the position where the maximum is detected.

15. The apparatus of claim 11 wherein the magnetic object is one of a mine, an improvised explosive device, a buried object, and a generator.

16. The apparatus of claim 11 further comprising a vehicle to which the sensor is coupled.

17. The apparatus of claim 11 further comprising drilling equipment to which the sensor is coupled.

18. The apparatus of claim 11 wherein the first circle lines on a plane that is perpendicular to the first path and the second circle lies on a plane that is perpendicular to the second path.

19. The apparatus of claim 11 comprising the object travelling on a first and second path in place of the sensor.

20. The apparatus claim 11 wherein the sensor is an optically pumped magnetometer.
